(19) United States
(12) Patent Application Publication
(10) Pub. No.: US 2021/0295609 A1
(43) Pub. Date: Sep. 23, 2021

(54) ACCOMMODATION AREA MANAGEMENT DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP); Shogo KOBAYASHI, Saitama (JP)

(73) Assignee: HONDA MOTOR CO., LTD., Tokyo (JP)

(21) Appl. No.: 17/207,071

(22) Filed: Mar. 19, 2021

(30) Foreign Application Priority Data
Mar. 19, 2020 (JP) 2020-050301

(51) Int. Cl. G07B 15/02; G06Q 10/02

(52) U.S. Cl. CPC G07B 15/02; G06Q 2240/00; G06Q 10/02

(57) ABSTRACT

An accommodation area management device includes a reservation reception unit configured to receive an intention to use the accommodation area when a moving body uses an accommodation area, a use fee determination unit configured to determine a use fee of the accommodation area, and an entry and exit management unit configured to manage an entry of the moving body into the accommodation area and an exit of the moving body from the accommodation area. The entry and exit management unit is configured to manage at least one of a number of times of the entry and a number of times of the exit of the moving body during a use time. The use fee determination unit is configured to determine the use fee based upon at least one of the number of times of the entry and the number of times of the exit of the moving body.

### CROSS-REFERENCE TO RELATED APPLICATIONS

This application is based on and claims priority under 35 USC 119 from Japanese Patent Application No. 2020-050301 filed on Mar. 19, 2020.

### TECHNICAL FIELD

The present disclosure relates to an accommodation area management device.

### BACKGROUND ART

In a related art, a parking system which allows an exit from a parking lot and a re-entry thereinto is known for the purpose of improving the usability of the parking lot. For example, a parking system described in JP-A-2014-075081 discloses that when a vehicle re-enters a parking lot after the vehicle exits therefrom, a parking determination device determines whether the vehicle is continuously park or newly park based upon a comparison result between plate information after the re-entry and plate information before the exit.

However, when the exit from the parking lot and the re-entry thereinto are allowed, a parking management system is required to perform management associated with the exit and the re-entry of the vehicle. For example, in recent years, automatic driving draws attention, and an automatic valet parking type parking lot which automatically drives a vehicle between a predetermined boarding area and a parking area can be considered.

In an accommodation area such as the automatic valet parking type parking lot, particularly, management associated with the exit and the re-entry of a moving body such as a vehicle, or the like is complicated. Even in an accommodation area other than the automatic valet parking type, it is naturally required to perform the management associated with the exit and the re-entry of the moving body.

### SUMMARY OF INVENTION

The present disclosure provides an accommodation area management device capable of improving the convenience of an accommodation area and smoothly operating the accommodation area.

According to the present disclosure, there is provided an accommodation area management device, which manages an accommodation area for accommodating a moving body, the accommodation area management device includes a reservation reception unit configured to receive an intention to use the accommodation area when the moving body uses the accommodation area, a use fee determination unit configured to determine a use fee of the accommodation area, and an entry and exit management unit configured to manage an entry of the moving body into the accommodation area and an exit of the moving body from the accommodation area, in which the entry and exit management unit is configured to manage at least one of a number of times of the entry and a number of times of the exit of the moving body during a use time, and the use fee determination unit is configured to determine the use fee based upon at least one of the number of times of the entry and the number of times of the exit of the moving body.

According to the present disclosure, it is possible to improve the convenience of an accommodation area and to smoothly operate the accommodation area.

### BRIEF DESCRIPTION OF DRAWINGS

FIG. 1 is a diagram illustrating an example of a configuration of a vehicle system according to the embodiment;

FIG. 2 is a diagram illustrating an example of a parking lot managed by a parking lot management device of the embodiment;

FIG. 3 is a diagram illustrating an example of a configuration of the parking lot management device of the embodiment;

FIG. 4 is a diagram illustrating an example of a parking space status table;

FIG. 5 is a diagram illustrating an example of a fee table; and

FIG. 6 is a diagram illustrating another example of the fee table.

### DESCRIPTION OF EMBODIMENTS

Hereinafter, an embodiment of an accommodation area management device of the present disclosure will be described with reference to the accompanying drawings. The following embodiment will describe an example in which a moving body in the present disclosure is a vehicle and an accommodation area in the present disclosure is a parking lot. Further, the following embodiment will describe an example in which an accommodation area management device of the present disclosure is a parking lot management device for managing the parking lot.

[Vehicle System]

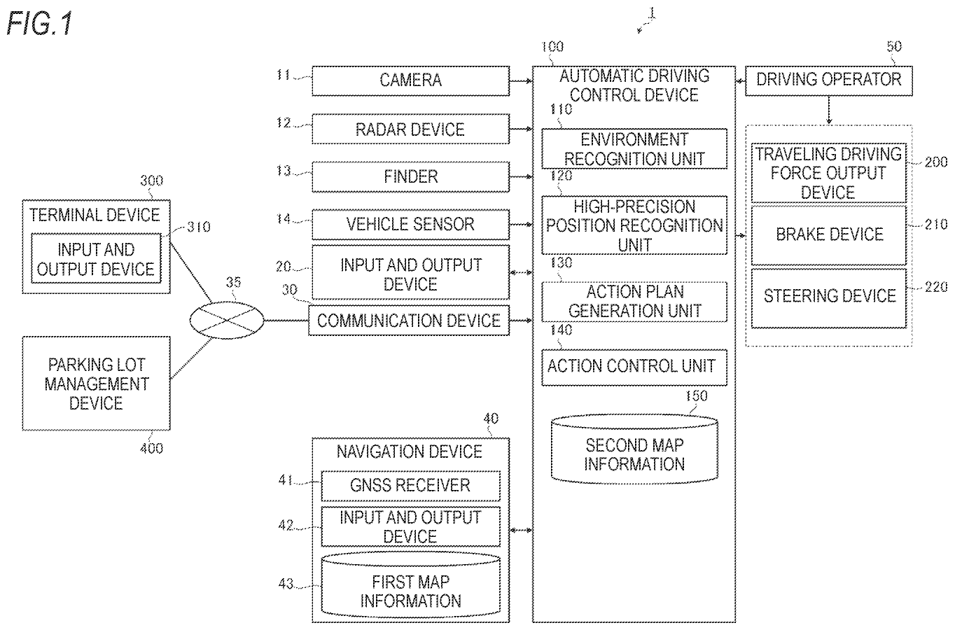

First, a vehicle of the embodiment (hereinafter, also referred to as a vehicle M) will be described. The vehicle M includes a vehicle system 1 illustrated in FIG. 1. The vehicle system 1 has a function capable of performing all driving tasks related to the vehicle M at least in a limited specific area (for example, in a parking lot PA which will be described later). Here, the driving task is, for example, a real-time driving function required for operating the vehicle M, such as controlling the movement of the vehicle M in the left-right direction (steering), controlling the movement in the front-rear direction (acceleration and deceleration), monitoring the driving environment, or the like, and a tactical function such as planning of a traveling track, or the like. The vehicle M is a vehicle including a drive source and wheels (for example, two wheels, three wheels, or four wheels) including a drive wheel driven by the power of the drive source. Further, the drive source of the vehicle M is, for example, an electric motor. The drive source of the vehicle M may he an internal combustion engine such as a gasoline engine, and a combination of the electric motor and the internal combustion engine.

As illustrated in FIG. 1, the vehicle system 1 includes a camera 11, a radar device 12, a finder 13, a vehicle sensor 14, an input and output device 20, a communication device 30, a navigation device 40, a driving operator 50, an automatic driving control device 100, a traveling driving force output device 200, a brake device 210, and a steering device 220. The respective devices are communicably connected to each other via a wired or wireless communication network. The communication network connecting the respective devices is, for example, a Controller Area Network (CAN).

The camera 11 is a digital camera which photographs the periphery of the vehicle M (for example, in front of the vehicle M), and outputs the image data obtained by photographing to the automatic driving control device 100. The radar device 12 is, for example, a radar device using radio waves in a millimeter wave band, detects a position of an object in the periphery of the vehicle M (for example, the front, the rear, and the side of the vehicle M), and outputs the detection result to the automatic driving control device 100.

The finder 13 is, for example, Laser Imaging Detection and Ranging (LIDAR), uses a predetermined laser beam to measure a distance to the object (a target object) existing in the periphery of the vehicle M (for example, the front, the rear, and the side of the vehicle M), and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around the vertical axis of the vehicle M, and an orientation sensor which detects the direction of the vehicle M, or the like. Further, the vehicle sensor 14 includes a radio wave intensity sensor which detects the radio wave intensity (that is, a communication intensity) of radio waves used for communication by the communication device 30 which will be described later. The vehicle sensor 14 outputs the detection result of each sensor to the automatic driving control device 100.

The input and output device 20 includes an output device, which outputs various information to a user of the vehicle M, and an input device, which receives various input operations from the user of the vehicle M. In the embodiment, the user is not limited to a person who manages or owns the vehicle M and uses the vehicle M. For example, the user may be a person who uses the vehicle M on behalf of the person who manages or owns the vehicle M at the request of the person who manages or owns the vehicle M. The output device of the input and output device 20 is, for example, a display which performs displaying based upon the processing result of the automatic driving control device 100. The output device may he a speaker, a buzzer, an indicator light, or the like. Further, the input device of the input and output device 20 is, for example, a touch panel or an operation button (a key, a switch, or the like) which outputs an operation signal corresponding to the input operation received from the user to the automatic driving control device 100.

The communication device 30 is connected to a network 35 and communicates with another device provided outside the vehicle system 1 via the network 35. The network 35 is, for example, a mobile communication network, a Wi-Fi network, Bluetooth (registered trademark), Dedicated Short Range Communication (DSRC), or the like.

The communication device 30 communicates with, for example, a terminal device 300 carried by the user of the vehicle M and a parking lot management device 400 which manages a parking lot PA in which the vehicle M can be parked. The terminal device 300 is, for example, a smartphone, a tablet terminal, or the like, and is an electronic device connected to the network 35 and including an input and output device 310. The input and output device 310 is, for example, a display, which displays various information to the user, a touch panel, which receives the input operation of the user, or the like. The parking lot PA and the parking lot management device 400 will be described later.

The navigation device 40 includes a Global Navigation Satellite System (GNSS) receiver 41 and an input and output device 42. Further, the navigation device 40 includes a storage device (not illustrated) such as a flash memory or the like, and first map information 43 is stored in the storage device. The first map information 43 is, for example, information representing a road shape by a link indicating a road and a node connected by the link. Further, the first map information 43 may include information representing the curvature of the road and a Point Of Interest (POI).

The GNSS receiver 41 specifies the latitude and longitude of a point where the vehicle M is positioned as the position of the vehicle M based upon the signal received from a GNSS satellite. Further, the navigation device 40 may specify or correct the position of the vehicle M by an Inertial Navigation System (INS) using the output of the vehicle sensor 14.

The input and output device 42 includes an output device, which outputs various information to the user of the vehicle M, and an input device, which receives various input operations from the user of the vehicle M. The output device of the input and output device 42 is, for example, a display which performs displaying based upon the processing result of the navigation device 40 (for example, displays a route on the map, which will be described later). Further, the input device of the input and output device 42 is, for example, a touch panel or an operation button (a key, a switch, or the like) which outputs the operation signal corresponding to the input operation received from the user to the navigation device 40. The input and output device 42 may be shared with the input and output device 20.

For example, the navigation device 40 determines a route from the position of the vehicle M specified by the GNSS receiver 41 to the destination inputted by the user (hereinafter, also referred to as the route on the map) with reference to the first map information 43. Next, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by a function of the terminal device 300. Further, for example, the communication device 30 may be configured to transmit the information indicating the position of the vehicle M and the destination inputted by the user to a server device (a navigation server) outside the vehicle system 1, thereby realizing the function of the navigation device 40 by the server device.

The driving operator 50 includes an operator such as an accelerator pedal, a brake pedal, a shift lever, a steering wheel, a variant steering wheel, a joystick, and the like. The driving operator 50 is provided with a sensor, which detects the amount of the operation or the presence or absence of operation on the driving operator 50. The detection result by the sensor of the driving operator 50 is outputted to a part or all of the automatic driving control device 100, the traveling driving force output device 200, the brake device 210, and the steering device 220.

The traveling driving force output device 200 outputs the traveling driving force (torque) for the vehicle M to travel to the drive wheel. The traveling driving force output device 200 includes, for example, an electric motor and an electric motor Electronic Control Unit (ECU) which controls the electric motor. The electric motor ECU controls the electric motor based upon the detection result by the sensor of the driving operator 50 (for example, the accelerator pedal) and control information from the automatic driving control device 100. Further, when the vehicle M includes an internal combustion engine and a transmission as a drive source, the traveling driving force output device 200 may include the internal combustion engine, the transmission, and the ECU which controls the internal combustion engine and the transmission.

The brake device 210 includes, for example, a brake caliper, a cylinder which transmits hydraulic pressure to the brake caliper, an electric motor which generates the hydraulic pressure in the cylinder, and a brake ECU. The brake ECU controls the electric motor of the brake device 210 based upon the detection result by the sensor of the driving operator 50 (for example, the brake pedal) and the control information from the automatic driving control device 100, and outputs the brake torque in accordance with a brake operation to each wheel.

The steering device 220 includes, for example, a steering ECU and an electric motor. The electric motor of the steering device 220 changes the direction of the steering wheel by, for example, applying a force to a rack and pinion mechanism. The steering ECU drives the electric motor of the steering device 220 based upon the detection result by the sensor of the driving operator 50 (for example, the steering wheel) and the control information from the automatic driving control device 100, and changes the direction of the steering wheel.

[Automatic Driving Control Device]

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like accessible to each functional unit (for example, the high-precision position recognition unit 120) of the automatic driving control device 100, and second map information 150 is stored in the storage device.

The second map information 150 is more accurate map information than the first map information 43. The second map information 150 includes, for example, information indicating the center of a lane, information indicating a lane boundary line (for example, a road lane marking), and the like. The second map information 150 may include road information, traffic regulation information, address information, facility information, telephone number information, and the like.

Further, the second map information 150 may be updated at any time when the communication device 30 communicates with another device. For example, when the vehicle M enters the parking lot PA, the communication device 30 receives information indicating the lanes in the parking lot PA, the position of each parking space, and the like (hereinafter, also referred to as map information in the parking lot) from the parking lot management device 400. Next, the automatic driving control device 100 updates the second map information 150 to incorporate the received map information in the parking lot into the second map information 150. As a result, the automatic driving control device 100 can specify the position of each parking space in the parking lot PA, or the like with reference to the second map information 150. Further, the second map information 150 may be updated when the communication device 30 communicates with a server, which distributes the map information, or the like.

The environment recognition unit 110 performs sensor fusion processing on the information to be acquired by a part or all of the camera 11, the radar device 12, and the finder 13, recognizes an object existing in the periphery of the vehicle M and also recognizes the position of the object. The environment recognition unit 110 recognizes, for example, obstacles, road shapes, traffic lights, guardrails, utility poles, surrounding vehicles (including the traveling status, such as the speed, acceleration, or the like, and parking state), lane marks, pedestrians, or the like, and also recognizes positions thereof.

The high-precision position recognition unit 120 recognizes the detailed position and posture of the vehicle M with reference to the position of the vehicle M specified by the navigation device 40, the detection result by the vehicle sensor 14, the image photographed by the camera 11, the second map information, or the like. The high-precision position recognition unit 120 recognizes, for example, the traveling lane on which the vehicle M is traveling, or recognizes a relative position and a posture of the own vehicle with respect to the traveling lane. The high-precision position recognition unit 120 also recognizes, for example, the position of the vehicle M in the parking lot PA, or the like.

The action plan generation unit 130 generates an action plan of the vehicle M. Specifically, the action plan generation unit 130 generates a target track, on which the vehicle M will travel in the future, as an action plan of the vehicle M. For example, the target track is information represented by arranging points (track points) to be reached by the vehicle M for each predetermined traveling distance (for example, about several [m]). Further, the target track may include information on speed elements such as the target speed, the target acceleration, and the like of the vehicle M at each predetermined time or at each track point. The action plan generation unit 130 generates the action plan, for example, according to an instruction of the parking lot management device 400 received by the communication device 30.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based upon the speed element associated with the target track, or controls the steering device 220 according to a curvature degree of the target trajectory.

Each functional unit of the automatic driving control device 100 is realized, for example, when a central processing unit (CPU) executes a predetermined program (software). A part or all of the functional units of the automatic driving control device 100 may be realized by hardware, such as Large Scale Integration (LSI), an Application Specific Integrated Circuit (ASIC), a Field-Programmable Gate Array (FPGA), and a Graphics Processing Unit (GPU), or the like, and for example, the storage device for storing the second map information 150 and the high-precision position recognition unit 120 may be realized by a Map Positioning Unit (MPU). A part or all of the functional units of the automatic driving control device 100 may be realized by the cooperation of the software and the hardware.

[Parking Lot Managed by Parking Lot Management Device]

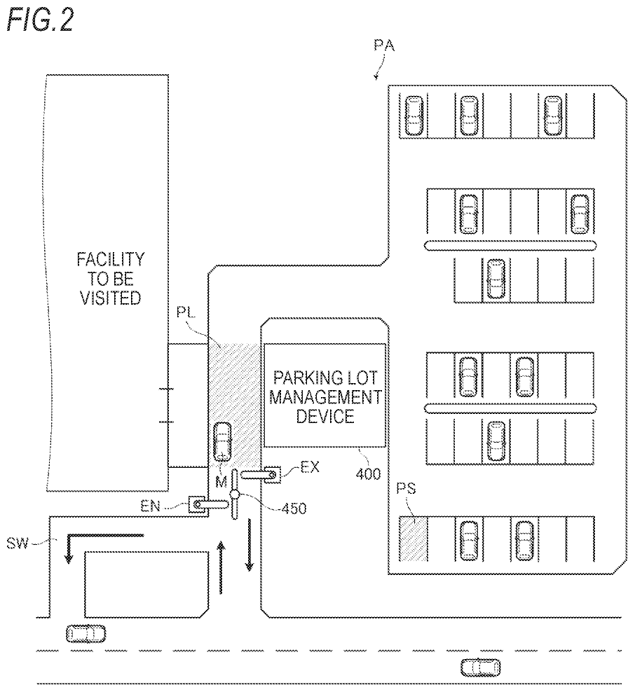

Next, an example of the parking lot PA will he described with reference to FIG. 2. As illustrated in FIG. 2, the parking lot PA is a parking lot managed by the parking lot management device 400 and is an automatic valet parking type parking lot provided as an annex in a visiting facility to be visited by a user. The parking lot PA includes a plurality of parking spaces PS capable of accommodating a vehicle (for example, the vehicle M) and a boarding area PL provided in front of the plurality of parking spaces PS.

Further, an entrance gate EN, which the vehicle passes through when entering the parking lot PA, and an exit gate EX, which the vehicle passes through when exiting from the parking lot PA, are provided in front of the boarding area PL of the parking lot PA. The vehicle entering into the entrance gate EN and the vehicle exiting from the exit gate EX are monitored by a photographing device 450 at the entrance gate EN and the exit gate EX. The photographing device 450 is, for example, a digital camera or a digital video using a solid-state imaging device such as a CCD, a CMOS, and the like, and periodically transmits a captured image or a captured video to the parking lot management device 400. The image or video periodically transmitted by the photographing device 450 can be used as information for allowing the parking lot management device 400 to recognize the number of times of an entry of the vehicle and the number of times of an exit of the vehicle.

Hereinafter, an example, in which the user of the vehicle M uses the parking lot PA, will be described.

Before using the parking lot PA, the user of the vehicle M makes a reservation for using the parking lot PA with respect to the parking lot management device 400, which manages the parking lot PA, by using the terminal device 300. For example, the user of the vehicle M inputs a date and time of using the parking lot PA and identification information of the vehicle M into the terminal device 300, and transmits these information to the parking lot management device 400, thereby making a reservation for using the parking lot PA. After that, when the date and time of the reservation for using the parking lot PA are reached, the user of the vehicle M drives up to the boarding area PL through the entrance gate EN in the vehicle M, and gets off from the vehicle M at the boarding area PL.

After the user gets off the vehicle M, the vehicle M performs automatic driving and starts a self-propelled entry event to move the vehicle M to the parking space PS in the parking lot PA. For example, the user transmits a request for starting the self-propelled entry event to the parking lot management device 400 by using the terminal device 300. In response to the request, the parking lot management device 400 instructs the vehicle M to perform the self-propelled entry event for allowing the vehicle M to be parked in a predetermined parking space PS. According to this instruction, the vehicle M moves to the parking space PS instructed by the parking lot management device 400 while being guided by the parking lot management device 400 and performing sensing by the camera 11, the radar device 12, the finder 13, or the like.

Further, when the vehicle M exits, the vehicle M performs the automatic driving and performs a self-propelled exit event to move the vehicle M from the parking space PS to the boarding area PL. For example, the user transmits a request for starting the self-propelled exit event to the parking lot management device 400 by using the terminal device 300. In response to the request, the parking lot management device 400 instructs the vehicle M to perform the self-propelled exit event to move the vehicle M from the parking space PS, where the vehicle M is parked, to the boarding area PL. According to this instruction, the vehicle M moves to the boarding area PL while being guided by the parking lot management device 400 and performing sensing by the camera 11, the radar device 12, the finder 13, or the like. The user of the vehicle M gets on the vehicle M at the boarding area PL and exits from the parking lot PA through the exit gate EX.

Further, the user can perform the exit and the re-entry within the use time of the vehicle M. Even at this time, the user transmits the request for starting the self-propelled exit event to the parking lot management device 400 by using the terminal device 300, such that the user can get on the vehicle M at the boarding area PL and exit from the parking lot PA through the exit gate EX. Further, at the time of the re-entry, the vehicle M can re-enter the parking space PS by transmitting the request for starting the self-propelled entry event to the parking lot management device 400 by using the terminal device 300. Further, the user can declare that he or she intends to re-enter thereinto when transmitting the request for starting the self-propelled exit event by using the terminal device 300.

[Parking Lot Management Device]

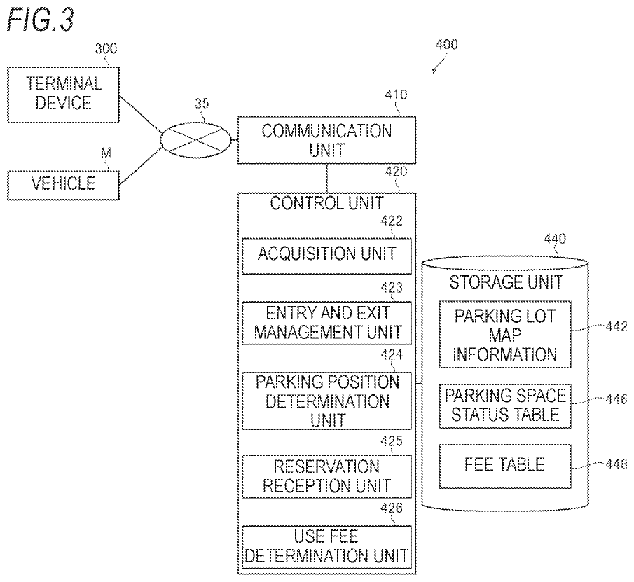

Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, an entry and exit management unit 423, a parking position determination unit 424, a reservation reception unit 425, and a use fee determination unit 426. Each component of the control unit 420 may be realized, for example, when a hardware processor such as a CPU executes a program (software). A part or all of these components may be realized by hardware, such as LSI, an ASIC, an FPGA, a GPU, and the like (including a circuit unit; circuitry), or may be realized by the cooperation of the software and the hardware. The program may be stored in advance in a storage device, such as an HDD, a flash memory, and the like (a storage device including a non-transient storage medium), may be stored in a removable storage medium (the non-transient storage medium) such as a DVD, a CD-ROM, or the like and may be installed by attaching the storage medium to a drive device, and may be a program managed by another server and executed.

Information such as parking lot map information 442, a parking space state table 446, a fee table 448, or the like is stored in the storage unit 440. The storage unit 440 is realized by an HDD, a flash memory, or the like.

The communication unit 410 wirelessly (for example, the network 35) communicates with the vehicle M or the terminal device 300 of the user. The control unit 420 guides the vehicle M to the parking space PS based upon the information acquired via the communication unit 410 and the information stored in the storage unit 440. The parking lot map information 442 is information which geometrically represents a structure of the parking lot PA. Further, the parking lot map information 442 includes coordinates for each parking space PS.

The reservation reception unit 425 receives the intention of use, that is, a use reservation when the vehicle M uses the parking lot PA via the communication unit 410. The reservation reception unit 425 acquires a date and time (including scheduled entry time and scheduled exit time) to be used when receiving the use reservation and the identification information of the vehicle M. The identification information of the vehicle M is, for example, a vehicle number of a vehicle number plate (so-called a license plate), a chassis number, or the like. The reservation reception unit 425 is not necessarily limited to acquiring desired environment information from the vehicle M and the terminal device 300 of the user, but may receive the use reservation from a device installed in the parking lot PA (for example, the entrance gate of the parking lot PA).

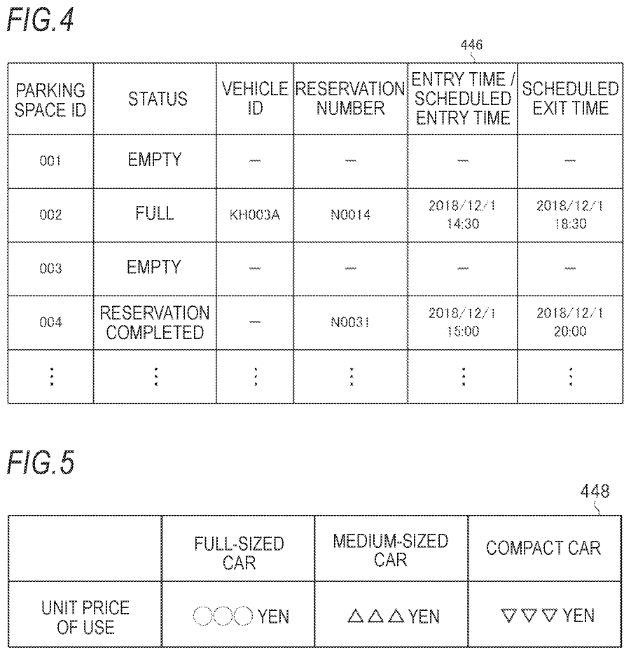

The acquisition unit 422 acquires parking space information of the vehicle M already being parked in the parking lot PA and parking space information of the vehicle M already being reserved for use in the parking lot PA via the communication unit 410. The parking space information is stored, for example, in the form of the parking space status table 446. As illustrated in FIG. 4, the parking space status table 446 includes; for example, information indicating whether a parking space ID, which is identification information of the parking space PS, is in a vacant status, a full (parked) status, or a reserved status; a vehicle ID which is the identification information of the parked vehicle M when the parking space ID is in the full status; the entry time and the scheduled parking-space exit time of the vehicle M when the parking space ID is in the full status; a reservation number when the parking space ID is in the reserved status; and the scheduled entry time and the scheduled exit time when the parking space ID is in the reserved status. The entry time is recorded in association with the vehicle ID of the vehicle M when the vehicle M enters the parking space PS. The scheduled entry time and the scheduled exit time are recorded in association with the reservation number at the time of making a reservation.

The parking position determination unit 424 determines a parking position of the vehicle M based upon the information acquired by the reservation reception unit 425 and the parking space information acquired by the acquisition unit 422. The information acquired by the reservation reception unit 425 may include information such as the size of the vehicle M in addition to the date and time (including the scheduled entry time and the scheduled exit time) to be used when receiving the use reservation, and the identification information of the vehicle M.

The entry and exit management unit 423 manages the entry of the vehicle M into the parking lot PA and the exit of the vehicle M from the parking lot PA during the use time. Specifically, the entry and exit management unit 423 counts the entry of the vehicle M into the parking lot PA and the exit of the vehicle M from the parking lot PA during the use time. The entry and exit management unit 423 may count the number of times of the exit and the number of times of the entry, only when receiving the declaration of the user which he or she intends to re-enter from the terminal device 300.

The entry and exit management unit 423 may count the number of times of the entry based upon the number of times of receiving the request for starting the self-propelled entry event from the terminal device 300 or the number of times of transmitting the request for starting the self-propelled entry event to the vehicle M, may count the number of times of the entry from the number of times of the entry recognized by the photographing device 450 provided at the entrance gate EN, and may count the number of times of the entry from the above-described both manners.

In the same manner, the entry and exit management unit 423 may count the number of times of the exit based upon the number of times of receiving the request for starting the self-propelled exit event from the terminal device 300 or the number of times of transmitting the request for starting the self-propelled exit event to the vehicle M, may count the number of times of the exit from the number of times of the exit recognized by the photographing device 450 provided at the exit gate EX, and may count the number of times of the exit from the above-described both manners.

The number of times of the entry into the parking lot PA and the number of times of the exit therefrom should be the same, the fact, which the number of times of the entry and the exit is one, indicates that the number of times of the entry and the number of times of the exit are respectively one, and the fact, which the number of times of the entry and the exit is two, indicates that the number of times of the entry and the number of times of the exit are respectively two. Therefore, managing the number of times of the entry and the number of times of the exit includes a case of counting only one of the number of times of the entry and the number of times of the exit.

The use fee determination unit 426 determines a use fee of the parking lot PA. The use fee determination unit 426 determines the use fee of the parking lot PA based upon at least one of the number of times of the entry and the number of times of the exit counted by the entry and exit management unit 423 (hereinafter, also referred to as the number of times of the entry and the exit). As described above, the number of times of the entry into the parking lot PA and the number of times of the exit therefrom should be the same. Further, the number of times of using the boarding area PL should be the same as the total number of times of the entry and the exit. For example, when the vehicle M enters once and exits once, the number of times of using the boarding area PL becomes two. Therefore, the number of times of the entry and the exit may be derived from the number of times of using the boarding area PL.

The use fee determination unit 426 may determine the use fee based upon use time (parking time) and the size of the vehicle M (a full-sized car, a medium-sized car, and a compact car) in addition to the number of times of the entry and the exit, and may change the use fee depending on a parking time zone (early morning, midnight, daytime, or the like), a congestion situation of the parking lot PA (when the parking lot PA is congested, and when parking lot PA is not congested), or the like. The use fee determination unit 426 changes the use fee based upon the use situation of the parking lot PA, thereby making it possible to collect the use tee in accordance with the load of the parking lot management device 400. Further, the use fee changes based upon the use situation of the parking lot PA, thereby making it possible to attract a user and improve the operation rate of the parking lot PA.

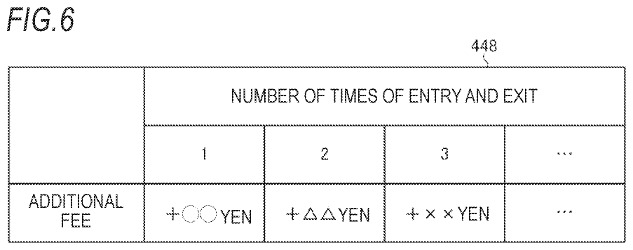

As illustrated in FIGS. 5 and 6, the use fee determined by the use fee determination unit 426 may be stored in the form of the fee table 448 in association with the vehicle information and the number of times of the entry and the exit. FIG. 5 illustrates the fee table 448 in which the size of the vehicle M and unit price of use are associated with each other, and FIG. 6 illustrates the fee table 448 in which the number of times of the entry and the exit and an additional fee are associated with each other.

For example, the use fee determination unit 426 determines the use fee by multiplying the unit price of use based upon the size of the vehicle by the use time, and by further adding the additional fee in accordance with the number of times of the entry and the exit. Further, the use tee determination unit 426 may also determine the use fee by adding a point for each item and by multiplying a total point by a predetermined point unit price. The parking position determination unit 424 may withdraw the use fee determined by the use fee determination unit 426 from a pre-registered hank account, a credit card, or the like after the reservation time ends, or may collect the use fee at the exit gate EX when the vehicle M does not re-enter.

In this manner, the parking lot management device 400 can improve the convenience of the parking lot PA by allowing the exit and the re-entry of the vehicle M within the reservation time. On the other hand, the parking lot management device 400 is required to manage the exit and the re-entry of the vehicle M. Particularly, the automatic valet parking type accommodation area described in the embodiment is required to perform processing associated with the self-propelled entry event and the self-propelled exit event. Therefore, the use fee determination unit 426 determines the use fee based upon the number of times of the entry and the exit, such that the parking lot management device 400 can obtain the use fee in accordance with the load and can smoothly operate the parking lot PA. Therefore, in the case of two vehicles M parked in the parking lot PA for the same time, a use fee for a vehicle once exiting from the parking lot PA and re-entering thereinto can be set higher than a use fee for a vehicle continuously being parked in the parking lot PA without exit.

Further, a plurality of times of the exit and the re-entry may cause congestion at the boarding area PL. Therefore, the number of times of the exit and the re-entry is reflected in the use fee, thereby making it possible to suppress the plurality of times of the exit and the re-entry.

The use fee determination unit 426 may determine the use fee based upon the end time of the reservation time when the reservation time ends while the vehicle M is out of the parking lot PA during the reservation time. On the other hand, when the communication unit 410 receives the user's intention to end the use before the end time of the reservation time while the vehicle M is out of the parking lot during the reservation time, the use fee determination unit 426 may determine the use fee based upon the time when the intention to end the use is received.

For example, when the vehicle M reserved for the use from 10:00 to 16:00 exits from the parking lot PA at 14:00 and the time reaches 16:00 in a state where the vehicle M does not return to the parking lot PA, the use fee determination unit 426 can collect the use fee for 6 hours from 10:00 to 16:00. Further, when the user's intention to end the use is received from the vehicle M at 15:00, the use fee determination unit 426 may collect the use fee for 5 hours from 10:00 to 15:00.

After receiving the user's intention to end the use, the parking lot management device 400 can park another vehicle in the parking space PS where the vehicle M has been parked. Even though the vehicle M is allowed to exit from the parking space PS during the reservation time in this manner, the use fee is determined based upon the end time of the reservation time or the time when the intention to end the use is received, such that the parking lot management device 400 can collect an appropriate use fee depending on the situation.

The use fee determination unit 426 can determine the use tee based upon the time when the intention to end the use is received only when another use reservation is made in the parking space PS where the vehicle M has been stopped, before the end time of the reservation time. By performing the above-described restriction, the parking lot management device 400 can prevent the occurrence of opportunity loss. Another use reservation indicates that there is the intention to use the parking space PS by a user of another vehicle, the parking lot management device 400, and the like.

Further, the use fee determination unit 426 may give a notification to the vehicle M or the terminal device 300 of the user of the vehicle M when another use reservation is received while the vehicle M is out of the parking space PS during the reservation time. As a result, the user can confirm the intention to end the use, and the parking lot management device 400 can obtain an opportunity to acquire a new use reservation.

On the other hand, the entry and exit management unit 423 may prohibit the re-entry of the vehicle M for a predetermined period when the reservation time ends while the vehicle M is outside. When the reservation time ends while the vehicle M is outside, the re-entry of the vehicle M is prohibited for a predetermined period, thereby making it possible to encourage an appropriate operation of the parking lot PA. For example, the vehicle M whose re-entry is prohibited can return to an original road from a branch road SW provided in front of the entrance gate EN. Instead of prohibiting the re-entry of the vehicle M, the entry and exit management unit 423 may set the use fee of the vehicle M to be high for a predetermined period after the reservation time ends. Accordingly, the user can be encouraged to appropriately operate the parking lot PA.

The embodiment describes that a so-called vehicle is parked in a parking lot. However, an idea of the present disclosure is not limited to such an embodiment and is also applied to a moving body including a vehicle (for example, a robot). That is, the present disclosure also includes a case where the moving body is accommodated in an accommodation area where the moving body can be accommodated. In consideration of this idea, “parking” is extended to a concept of “stop”, and the “parking lot management device” of the embodiment is extended to a concept of the “accommodation area management device”. “Exit” and “entry” are extended to concepts of “leaving” and “approaching”.

While a mode for implementing the present disclosure is described above by using the embodiment, the present disclosure is not limited to the embodiment, and various modifications and substitutions can be added within the scope not departing from the gist of the present disclosure.

Further, at least the following items are described in this specification. Components or the like corresponding to the above-described embodiments are shown in parentheses, but the present disclosure is not limited thereto.

An accommodation area management device (parking lot management device 400), which manages an accommodation area (parking lot PA) for accommodating a moving body (vehicle M), the accommodation area management device including:

a reservation reception unit (reservation reception unit 425) configured to receive an intention to use the accommodation area when the moving body uses the accommodation area;

a use fee determination unit determination unit 426) configured to determine a use fee of the accommodation area; and

an entry and exit management the unit (entry and exit management unit 423) configured to manage an entry of the moving body into the accommodation area and an exit of the moving body from the accommodation area, in which:

the entry and exit management unit is configured to manage at least one of a number of times of the entry and the number of times of the exit of the moving body (number of times of entry and exit) during a use time; and

the use fee determination unit is configured to determine the use fee based upon at least one of the number of times of the entry and the number of the times of the exit of the moving body.

According to (1), the accommodation area management device can improve the convenience of the accommodation area by allowing the exit and the re-entry of the moving body during the use time. On the other hand, since the accommodation area management device is required to manage the exit and the re-entry of the moving body, the accommodation area management device can smoothly operate the accommodation area by determining the use fee based upon at least one of the number of times of the exit and the number of times of the entry.

(2) The accommodation area management device according to (1), in which

the use fee determination unit is configured to:

determine the use fee based upon an end time of reservation time when the reservation time ends while the moving body is outside during the reservation time; and

determine the use fee based upon time when an intention to end the use is received, when the intention to end the use is received before the end time of the reservation time while the moving body is outside during the reservation time.

According to (2), even though the moving body is allowed to exit during the reservation time, since the use fee is determined based upon the end time of the reservation time or the time when the intention to end the use is received, the accommodation area management device can collect an appropriate use fee depending on the situation.

(3) The accommodation area management device according to (2), in which

the use fee is determined based upon the time when the intention to end the use is received, only when another use reservation is made at an accommodation position where the moving body has been stopped before the end time of the reservation time.

According to (3), the use fee is determined based upon the time when the intention to end the use is received, only when another use reservation is made at the accommodation position where the moving body has been stopped before the end time of the reservation time, thereby making it possible to prevent the occurrence of opportunity loss.

(4) The accommodation area management device according to (3), in which

the use fee determination unit is configured to give a notification to the moving body or a terminal device of a user of the moving body when the another use reservation is received while the moving body is outside during the reservation time.

According to (4), the use fee determination unit is configured to give the notification to the moving body or a terminal device of a user of the moving body when the another use reservation is received while the moving body is outside during the reservation time, and thus, the user can confirm the intention to end the use, and the accommodation area management device can obtain an opportunity to acquire a new use reservation.

(5) The accommodation area management device according to any one of (2) to (4), in which

the entry and exit management unit is configured to prohibit a re-entry of the moving body for a predetermined period when the reservation time ends while the moving body is outside.

According to (5), when the reservation time ends while the moving body is outside, the re-entry of the moving body is prohibited for a predetermined period, thereby making it possible to prompt an appropriate operation of the accommodation area.

(6) The accommodation area management device according to any one of (1) to (5), further including:

a communication unit (communication unit 410) configured to communicate with moving body or a terminal device (terminal device 300) of a user of the moving body, in which

the reservation reception unit is configured to receive the intention via the communication unit.

According to (6), since the reservation reception unit receives the intention regarding the use such as the use reservation via the communication unit, it becomes easy to acquire the intention of the user.

(7) The accommodation area management device according to any one of (1) to (6), in which:

the accommodation area includes a boarding area (boarding area PL) for allowing a user of the moving body to get on and off; and

the accommodation area is an automatic valet parking type accommodation area configured to automatically drive the moving body at least between the boarding area and an accommodation position accommodating the moving body.

According to (7), since the accommodation area management device is required to control the exit and the reentry of the moving body in the automatic valet parking type accommodation area, the use fee is determined based upon the number of times of the exit and the number of times of the entry, and thus, the accommodation area management device can collect the use fee in accordance with load thereof.

What is claimed is:

1. An accommodation area management device, which manages an accommodation area for accommodating a moving body, the accommodation area management device comprising:
a reservation reception unit configured to receive an intention to use the accommodation area when the moving body uses the accommodation area;
a use fee determination unit configured to determine a use fee of the accommodation area; and
an entry and exit management unit configured to manage an entry of the moving body into the accommodation area and an exit of the moving body from the accommodation area, wherein:
the entry and exit management unit is configured to manage at least one of a number of times of the entry and a number of times of the exit of the moving body during a use time; and
the use fee determination unit is configured to determine the use fee based upon at least one of the number of times of the entry and the number of times of the exit of the moving body.

2. The accommodation area management device according to claim 1, wherein the use fee determination unit is configured to:
determine the use fee based upon an end time of reservation time when the reservation time ends while the moving body is outside during the reservation time; and
determine the use fee based upon time when an intention to end the use is received, when the intention to end the use is received before the end time of the reservation time while the moving body is outside during the reservation time.

3. The accommodation area management device according to claim 2, wherein the use fee is determined based upon the time when the intention to end the use is received, only when another use reservation is made at an accommodation position where the moving body has been stopped before the end time of the reservation time.

4. The accommodation area management device according to claim 3, wherein
the use fee determination unit is configured to give a notification to the moving body or a terminal device of a user of the moving body when the another use reservation is received while the moving body is outside during the reservation time.

5. The accommodation area management device according to claim 2, wherein
the entry and exit management unit is configured to prohibit a re-entry of the moving body for a predetermined period when the reservation time ends while the moving body is outside.

6. The accommodation area management device according to claim 1, further comprising:
a communication unit configured to communicate with the moving body or a terminal device of a user of the moving body, wherein
the reservation reception unit is configured to receive the intention via the communication unit.

7. The accommodation area management device according to claim 1, wherein:
the accommodation area includes a boarding area for allowing a user of the moving body to get on and off; and
the accommodation area is an automatic valet parking type accommodation area configured to automatically drive the moving body at least between the boarding area and an accommodation position accommodating the moving body.
